(19) United States
(12) Patent Application Publication
(10) Pub. No.: US 2025/0159766 A1
(43) Pub. Date: May 15, 2025

(54) HEATABLE WIRED LAMINATED GLAZING WITH TEMPERATURE CONTROL

(71) Applicant: AGC GLASS EUROPE, Louvain-la-Neuve (BE)

(72) Inventors: Soufiane EL ABDOUNI, Gosselies (BE); Jean MASSON, Gosselies (BE); Julien PRUNIER, Gosselies (BE); Xavier LALOYAUX, Gosselies (BE)

(73) Assignee: AGC GLASS EUROPE, Louvain-la-Neuve (BE)

(21) Appl. No.: 18/729,591

(22) PCT Filed: Jan. 23, 2023
(86) PCT No.: PCT/EP2023/051504

§ 371 Date: Jul. 17, 2024

(30) Foreign Application Priority Data
Jan. 26, 2022 (EP) 22153520.6

(51) Int. Cl. H05B 3/86; B32B 17/10; G01S 7/481; H05B 1/02

(52) U.S. Cl. CPC H05B 3/86; B32B 17/10036; B32B 17/10385; G01S 7/4813; H05B 1/0236; B32B 2250/02; B32B 2305/345; B32B 2605/00; H05B 2203/014

(57) ABSTRACT

A heatable wired laminated glazing for a vehicle. The automotive glazing is designed to be placed in front of an optical sensor and includes an internal glass sheet facing the optical sensor, and an external glass sheet facing the outside of the vehicle. The glazing is laminated and features an interlayer, with conductive wires, laminating the internal glass sheet and the external glass sheet together. The glazing further features a flat connector, partially embedded, connected to the conductive wires, and extending along the internal glass sheet towards the face of the internal glass sheet opposite the interlayer. The flat connector includes a control circuit designed to control the embedded conductive wires an active regulation system, designed to be connected to a battery of the vehicle and at least one thermistor. The thermistor is connected to the control circuit through the flat connector.

### FIELD OF THE INVENTION

The present invention relates to the field of automotive heatable glazing, more specifically heatable wired laminated glazing. More specifically it relates to systems and methods to control temperature of such glazing.

### BACKGROUND OF THE INVENTION

In the scope of autonomous driving, it is important to keep the vision of the various optical sensors used on autonomous or semi-autonomous cars free from any obstruction to allow functionality under any weather condition. Frosted or misted glazing in front of an optical sensor usually disturbs or eventually prevents the optical sensor to acquire date. It is therefore of tremendous importance to defrost or demist as quick as possible, which is done through heating of the glazing.

Various solutions are known from the skilled in the art in order to heat an automotive glazing, and more specifically the windshield. Windshield is a laminated glazing, usually made of two glass sheets bound by an interlayer, usually a thermoplastic layer made of polyurethane (PU), polyvinyl butyral (PVB) or ethylene-vinyl acetate (EVA).

In order to heat such laminated glazing, thin conductive metallic wires may be embedded in the laminate, in contact with the interlayer and more particularly at least partially embedded in the interlayer, and contacting one of the inner face of one of the glass sheets. Such wires are used to heat the windshield (resistance heating by Joules effect) for defrosting and defogging. These wires may be made very thin, so as to minimize intrusion into the driver's field of view, and run from side to side or vertically along the windshield, following usually sinusoid-like paths such as described in EP3191303B1. They can also follow a snake path. Heatable wired glazings are well known from skilled man in the art.

The heating of an automotive glazing is usually limited so that the temperature of the glazing is kept below a maximal temperature value. For example, in Europe, a windshield of a car cannot be heated above 70° C. as the driver of the vehicle may touch the windshield while driving. It is also usually recommended not to heat any automotive glazing above a maximal temperature value. Moreover, and specifically regarding heated laminated glazing, the maximal temperature value to which the glazing is heated is linked to the laminate itself. A laminated glazing (or laminate) is a type of safety glass that holds together when shattered. In the event of breaking, it is held in place by a thermoplastic interlayer, typically of polyvinyl butyral (PVB), ethylene-vinyl acetate (EVA) or polyurethane (PU), between its two or more layers of glass. The interlayer keeps the layers of glass bonded even when broken, and its high strength prevents the glass from breaking up into large sharp pieces. Increasing the temperature of the glazing may damage the interlayer which is less resistant to high temperature than glass.

Such heating system usually uses voltage coming from the battery of the automotive vehicle. The voltage usually ranges from 9V to 16V. To limit the temperature reached by the glazing, a resistance is added to the heating circuit in order to limit the received voltage. The heating time is also defined so that the temperature of the glazing will never exceed the maximal temperature value. There is therefore no need to control the temperature of the glazing as both the resistance and the heating time have been predefined in order to avoid reaching such maximal temperature value.

However the actual tendency in automotive is towards defrosting or demisting as fast as possible. In order to heat the glazing as fast as possible, more power must be brought to the conductive wires. There are two possibilities: either the voltage at the entry of the heating circuit is increased, either the resistance of the heating circuit is decreased. The temperature of the glazing is therefore subjected to reach and exceed the maximal temperature value. It is therefore needed to know the temperature of the glazing during the heating.

Moreover, as the resistance of the heating circuit is lower and as the voltage may vary between 9 and 16V, it is needed to regulate accurately the heating of the glazing. Otherwise the temperature of the glazing may exceed the maximal temperature value. The regulation can be done by a signal given by the optical sensor that the glazing is defrosted or demisted. However, this signal is only given when the glazing is completely defrosted or demisted in the whole field of view (FOV) of the optical sensor. This leads to residual heat in the conductive wires which is dissipating for nothing. Besides, such regulation done by the optical sensor does not allow to avoid the voltage variation of the battery.

There is therefore a need for a solution to regulate the temperature of conductive wires embedded in a laminated glazing, allowing to defrost or demist quickly but without exceeding the maximum temperature value supported by the glazing.

### SUMMARY OF THE INVENTION

The present invention concerns a heated wired laminated glazing for a vehicle. The glazing is configured to be placed in front of an optical sensor. The glazing comprises an external glass sheet facing the outside of the vehicle, the external glass sheet having an external face and an internal face. The glazing further comprises an internal glass sheet facing the optical sensor, the internal glass sheet having an external face and an internal face. The glazing, being a laminated glazing, further comprises an interlayer laminating the external glass sheet and the internal glass sheet together. The interlayer comprises embedded conductive wires. The glazing further comprises a flat connector at least partially embedded between the interlayer and the external or the internal glass sheet. The flat connector extends along the internal glass sheet. The flat connector covers partially the external face of the internal glass sheet. The flat connector is connected to the embedded conductive wires. The flat connector comprises, on its part covering partially the external face of the internal glass sheet, a control circuit configured to control the embedded conductive wires. The flat connector further comprises, on its part covering partially the external face of the internal glass sheet, an active regulation system configured to be connected to a battery of the vehicle. The flat connector further comprises, on its part at least partially embedded between the interlayer and the external glass sheet or the internal glass sheet, at least one thermistor. The thermistor is connected to the control circuit through the flat connector.

The invention also relates to the use of such glazing as a windshield or a rearlite of a vehicle. It also relates to the use of such glazing as a cover of an optical sensor mounted on or inside a vehicle. It also relates to the use of such glazing as a part of an exterior trim element of a vehicle.

### BRIEF DESCRIPTION OF THE DRAWINGS

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1a illustrates an embodiment of a heatable wired laminated glazing according to the invention, viewed from the side.

FIG. 1b, FIG. 1c, FIG. 1d and FIG. 1e illustrate alternative embodiments of a heatable wired laminated glazing according to the invention, viewed from the side.

FIG. 2a illustrates a view from above of an embodiment of the present invention.

FIG. 2b illustrates a view from above of an alternative embodiment of the present invention.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes a heated wired laminated glazing for a vehicle. A vehicle includes car, van, lorry, motorbike, bus, tram, train, drone, airplane, helicopter and the like.

The glazing is configured to be placed in front of an optical sensor. An optical sensor is understood as a sensor which has at least a receiver active in the ultraviolet, visible or infrared wavelength, such as a camera or a rain sensor. It can also further comprise an emitter active in the ultraviolet, visible or infrared wavelength, such as a lidar.

The glazing is a laminated glazing. A laminated glazing refers to at least an internal glass sheet and an external glass sheet laminated by at least one interlayer. The external glass sheet faces the outside of the vehicle. The external glass sheet has an external face, facing the outside of the vehicle, and an internal face, facing the internal glass sheet. The internal glass sheet faces the optical sensor. The internal glass sheet has an external face, facing the optical sensor, and an internal face, facing the external glass sheet. The glass sheets can be made of (mineral) glass, more specifically a silica-based glass, such as soda-lime-silica, alumino-silicate or boro-silicate type glass.

The at least one interlayer laminates the internal glass sheet and the external glass sheet together. The at least one interlayer is usually made of polyurethane (PU), polyvinyl butyral (PVB) or ethylene-vinyl acetate (EVA).

In order to heat the laminated glazing (to defrost and/or defog), conductive wires are embedded in the interlayer, the wires being in the vicinity of (or in total or partial contact with) the internal face of the external glass sheet or of the internal glass sheet. In case of multiple interlayers, the conductive wires are in the vicinity of or in total or partial contact with either the internal face of the external glass sheet or of the internal glass sheet, either the interlayers. The conductive wires are usually made of tungsten or copper. These wires are very thin, generally of a width comprised between 10 microns and 50 microns. They usually run vertically or from side to side along the vehicle laminated glazing. The conductive wires may also follow a snake path. Conductive wires usually follow straight or sinusoid-like paths.

The glazing further comprises a flat connector. One example of such flat connector is a Kapton. The flat connector is at least partially embedded between the interlayer and the external or internal glass sheet.

It extends along the glazing. The flat connector is provided on a part of the surface of the external face of the internal glass sheet. The flat connector is connected to the embedded conductive wires. As an alternative, the flat connector can also be embedded between two interlayers.

The flat connector comprises, on its part covering partially the external face of the internal glass sheet, a control circuit configured to control the embedded conductive wires.

The flat connector further comprises, on its part covering partially the external face of the internal glass sheet, an active regulation system. This active regulation system maintains a constant voltage output even when changing input voltages and output currents. The active regulation system is connected to a battery of the vehicle. The advantage of using an active regulation system is to allow to stabilize the voltage coming from the battery of the vehicle. As an example, the voltage of a car can range from 4.5V to 36V. Using an active regulation system allows to stabilize the voltage at for example 5V. The control circuit of the heating circuit can therefore be alimented with a stabilized source.

The flat connector further comprises, on its part at least partially embedded between the interlayer and the external glass sheet or the internal glass sheet, at least one thermistor. A thermistor is a type of resistor whose resistance is dependent on temperature. It can therefore furnish information about temperature. There also exist electronic thermistors which give a signal with a frequency varying depending on the temperature. The thermistor is connected to the control circuit through the flat connector.

According to a preferred embodiment, the glazing further comprises at least one additional interlayer laminated between the external glass sheet and the internal glass sheet. In this case, the flat connector can still be at least partially embedded between the interlayer and the external glass sheet or the internal glass sheet. In an alternative embodiment, the flat connector is at least partially embedded between the interlayer and the at least one additional interlayer.

According to a preferred embodiment, the active regulation system is a DC-DC converter. A DC-DC converter is a high-frequency power conversion circuit. It uses high-frequency switching and inductors, transformers and capacitors to smooth out switching noise into regulated DC voltages. It maintains a constant voltage output even when changing input voltages and output currents.

According to a preferred embodiment, the optical sensor is a lidar and the glazing is transparent at the operating wavelength range of the lidar. Lidar is an acronym for “light detection and ranging”. It is sometimes called “laser scanning” or “3D scanning”. The technology uses eye-safe laser beams to create a 3D-representation of the surveyed environment. Operating wavelength of lidar compatible with the present invention is comprised between 750 and 1650 nm (usually referred to as near-infrared range). More specifically, known operating wavelengths of currently produced lidars compatible with the present invention are 850 nm, 905 nm, 940 nm, 1064 nm, 1310 nm, 1350 nm, 1550 nm, 1650 nm. An acceptable variance of 25 nm around the nominal value of the wavelength may be considered, such that, for example, a wavelength range of 1525 to 1575 nm may be accepted around the nominal value of 1550 nm.

According to a preferred embodiment, the glazing is a windshield, a rearlite or a sidelite of a vehicle.

According to a preferred embodiment, the glazing is a cover of an optical sensor mounted on or inside the vehicle.

According to a preferred embodiment, the glazing is a part of an exterior trim element. An exterior trim element includes bumper, window/door seal, wheel well, fender, headlight, mirror body and roof cover. Vehicle manufacturers use these exterior trim elements to add aesthetics, increase function, and add flexibility to the vehicle design.

The present invention also concerns the use of a glazing as described previously as a windshield, a rearlite or a sidelite of a vehicle.

The present invention also concerns the use of a glazing as described previously as a cover of an optical sensor mounted on or inside a vehicle.

The present invention also concerns the use of a glazing as described previously as a part of an exterior trim element of a vehicle.

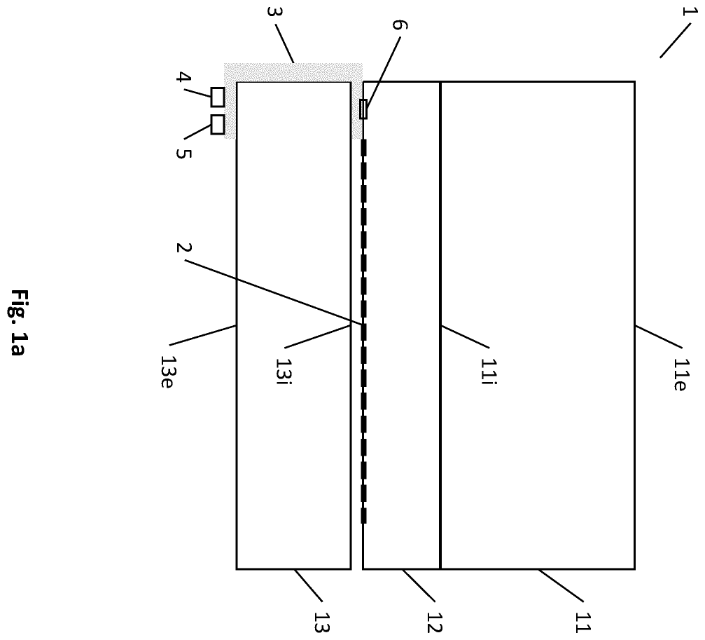

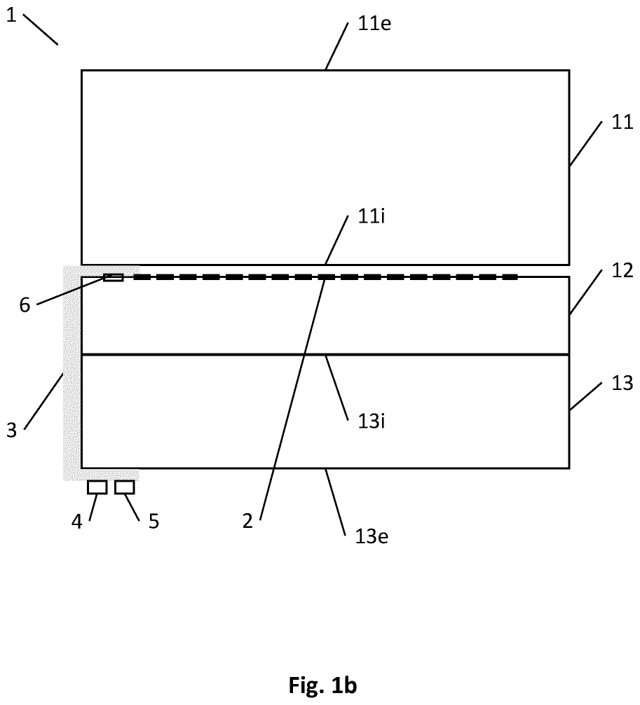

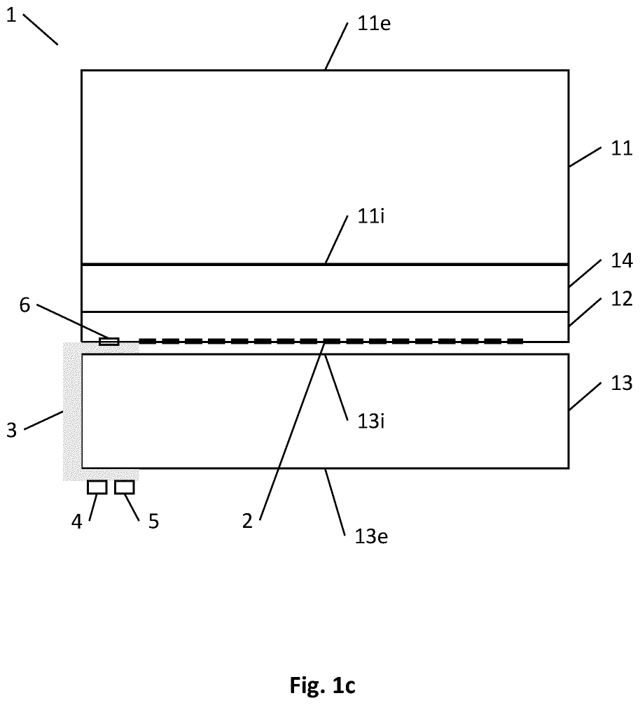

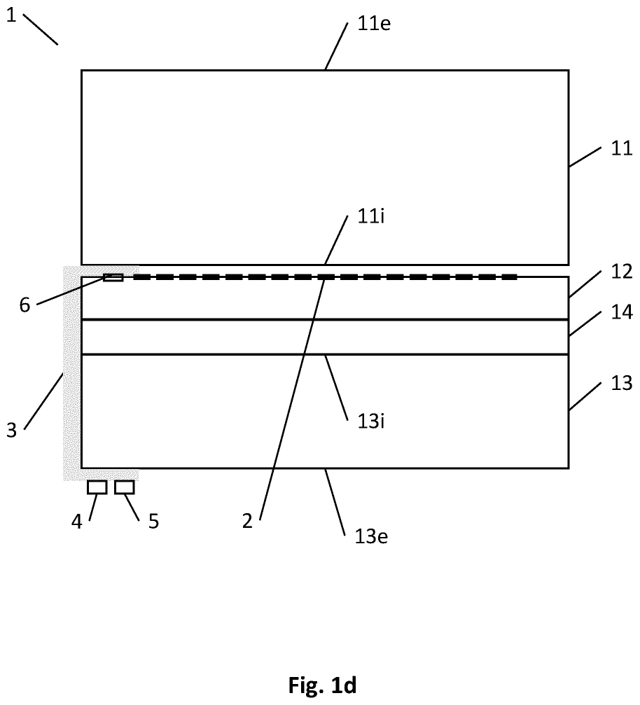

FIG. 1a shows a heated wired laminated glazing (1) viewed from the side. The glazing (1) comprises an external glass sheet (11) and an internal glass sheet (13), laminated together by an interlayer (12). Conductive wires (2) are embedded in the interlayer (12), facing the internal glass sheet (13). These conductive wires (2) are heated in order to defrost or demist the glazing (1).

A flat connector (3) is also at least partially embedded in the laminated glazing (1), between the interlayer (12) and the internal glass sheet (13). The flat connector (3) extends along the internal glass sheet (13). The flat connector (3) covers partially the external face (13e) of the internal glass sheet (13).

The flat connector (3) is connected to the embedded conductive wires (2).

The flat connector (3) comprises, on its part covering partially the external face (13e) of the internal glass sheet (13), a control circuit (4). The control circuit (4) allows to control the heating of the embedded conductive wires (2) through the flat connector (3).

The flat connector (3) further comprises, on its part covering partially the external face (13e) of the internal glass sheet (13), an active regulation system (5), such as a DC-DC converter. The active regulation system (5) is connected to a battery of the vehicle (not shown).

The flat connector (3) further comprises, on its part at least partially embedded between the interlayer (12) and the internal glass sheet (13), at least one thermistor (6). The thermistor is connected to the control circuit (4) through the flat connector (3).

On this figure, a gap is shown between the interlayer (12) and the internal glass sheet (13). This gap is only present for showing purpose in order not to render the figure too complex. This gap is not actually present in the laminate.

FIG. 1b shows an alternative heated wired laminated glazing (1) viewed from the side. The glazing (1) comprises an external glass sheet (11) and an internal glass sheet (13), laminated together by an interlayer (12). Conductive wires (2) are embedded in the interlayer (12), facing the external glass sheet (11). These conductive wires (2) are heated in order to defrost or demist the glazing (1).

A flat connector (3) is also at least partially embedded in the laminated glazing (1), between the interlayer (12) and the external glass sheet (11). The flat connector (3) extends along the internal glass sheet (13). The flat connector (3) covers partially the external face (13e) of the internal glass sheet (13).

The flat connector (3) is connected to the embedded conductive wires (2).

The flat connector (3) comprises, on its part covering partially the external face (13e) of the internal glass sheet (13), a control circuit (4). The control circuit (4) allows to control the heating of the embedded conductive wires (2) through the flat connector (3).

The flat connector (3) further comprises, on its part covering partially the external face (13e) of the internal glass sheet (13), an active regulation system (5), such as a DC-DC converter. The active regulation system (5) is connected to a battery of the vehicle (not shown).

The flat connector (3) further comprises, on its part at least partially embedded between the interlayer (12) and the external glass sheet (11), at least one thermistor (6). The thermistor is connected to the control circuit (4) through the flat connector (3).

On this figure, a gap is shown between the interlayer (12) and the external glass sheet (11). This gap is only present for showing purpose in order not to render the figure too complex. This gap is not actually present in the laminate.

FIG. 1c shows an alternative heated wired laminated glazing (1) viewed from the side. The glazing (1) comprises an external glass sheet (11) and an internal glass sheet (13), laminated together by an interlayer (12). Conductive wires (2) are embedded in the interlayer (12), facing the internal glass sheet (13). These conductive wires (2) are heated in order to defrost or demist the glazing (1). The glazing (1) further comprises an additional interlayer (14) between the interlayer (12) and the external glass sheet (11).

A flat connector (3) is also at least partially embedded in the laminated glazing (1), between the interlayer (12) and the internal glass sheet (13). The flat connector (3) extends along the internal glass sheet (13). The flat connector (3) covers partially the external face (13e) of the internal glass sheet (13). The flat connector (3) is connected to the embedded conductive wires (2).

The flat connector (3) comprises, on its part covering partially the external face (13e) of the internal glass sheet (13), a control circuit (4). The control circuit (4) allows to control the heating of the embedded conductive wires (2) through the flat connector (3).

The flat connector (3) further comprises, on its part covering partially the external face (13e) of the internal glass sheet (13), an active regulation system (5), such as a DC-DC converter. The active regulation system (5) is connected to a battery of the vehicle (not shown).

The flat connector (3) further comprises, on its part at least partially embedded between the interlayer (12) and the internal glass sheet (13), at least one thermistor (6). The thermistor is connected to the control circuit (4) through the flat connector (3).

On this figure, a gap is shown between the interlayer (12) and the internal glass sheet (13). This gap is only present for showing purpose in order not to render the figure too complex. This gap is not actually present in the laminate.

FIG. 1d shows an alternative heated wired laminated glazing (1) viewed from the side. The glazing (1) comprises an external glass sheet (11) and an internal glass sheet (13), laminated together by an interlayer (12). Conductive wires (2) are embedded in the interlayer (12), facing the external glass sheet (11). These conductive wires (2) are heated in order to defrost or demist the glazing (1). The glazing (1) further comprises an additional interlayer (14) between the interlayer (12) and the internal glass sheet (13)

A flat connector (3) is also at least partially embedded in the laminated glazing (1), between the interlayer (12) and the external glass sheet (11). The flat connector (3) extends along the internal glass sheet (13). The flat connector (3) covers partially the external face (13e) of the internal glass sheet (13).

The flat connector (3) is connected to the embedded conductive wires (2).

The flat connector (3) comprises, on its part covering partially the external face (13e) of the internal glass sheet (13), a control circuit (4). The control circuit (4) allows to control the heating of the embedded conductive wires (2) through the flat connector (3).

The flat connector (3) further comprises, on its part covering partially the external face (13e) of the internal glass sheet (13), an active regulation system (5), such as a DC-DC converter. The active regulation system (5) is connected to a battery of the vehicle (not shown).

The flat connector (3) further comprises, on its part at least partially embedded between the interlayer (12) and the external glass sheet (11), at least one thermistor (6). The thermistor is connected to the control circuit (4) through the flat connector (3).

On this figure, a gap is shown between the interlayer (12) and the external glass sheet (11). This gap is only present for showing purpose in order not to render the figure too complex. This gap is not actually present in the laminate.

FIG. 1e shows an alternative heated wired laminated glazing (1) viewed from the side. The glazing (1) comprises an external glass sheet (11) and an internal glass sheet (13), laminated together by two interlayer (12, 14). Conductive wires (2) are embedded in the interlayer (12), facing the additional interlayer (14). These conductive wires (2) are heated in order to defrost or demist the glazing (1).

A flat connector (3) is also at least partially embedded in the laminated glazing (1), between the two interlayers (12, 14). The flat connector (3) extends along the internal glass sheet (13). The flat connector (3) covers partially the external face (13e) of the internal glass sheet (13).

The flat connector (3) is connected to the embedded conductive wires (2).

The flat connector (3) comprises, on its part covering partially the external face (13e) of the internal glass sheet (13), a control circuit (4). The control circuit (4) allows to control the heating of the embedded conductive wires (2) through the flat connector (3).

The flat connector (3) further comprises, on its part covering partially the external face (13e) of the internal glass sheet (13), an active regulation system (5), such as a DC-DC converter. The active regulation system (5) is connected to a battery of the vehicle (not shown).

The flat connector (3) further comprises, on its part at least partially embedded between the two interlayers (12, 14), at least one thermistor (6). The thermistor is connected to the control circuit (4) through the flat connector (3).

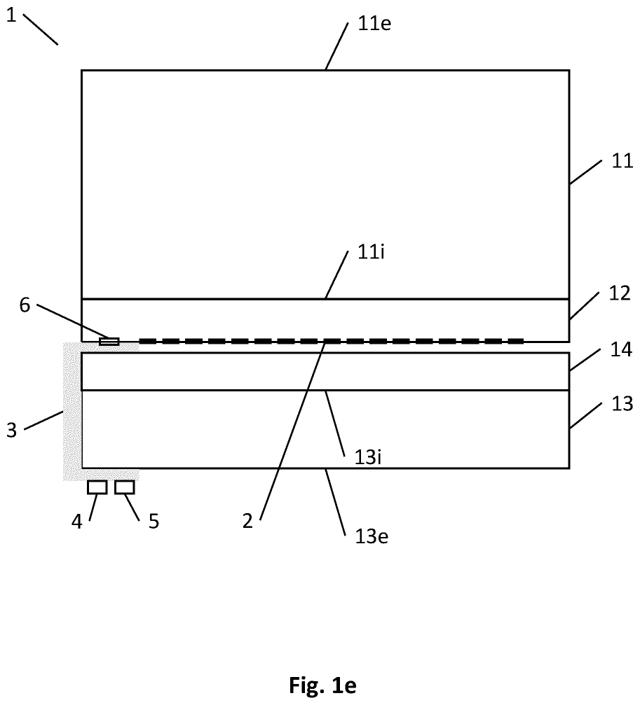

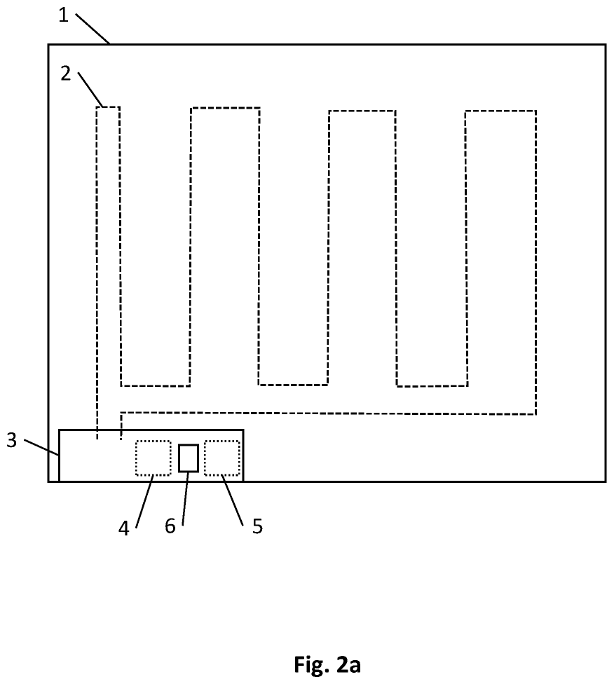

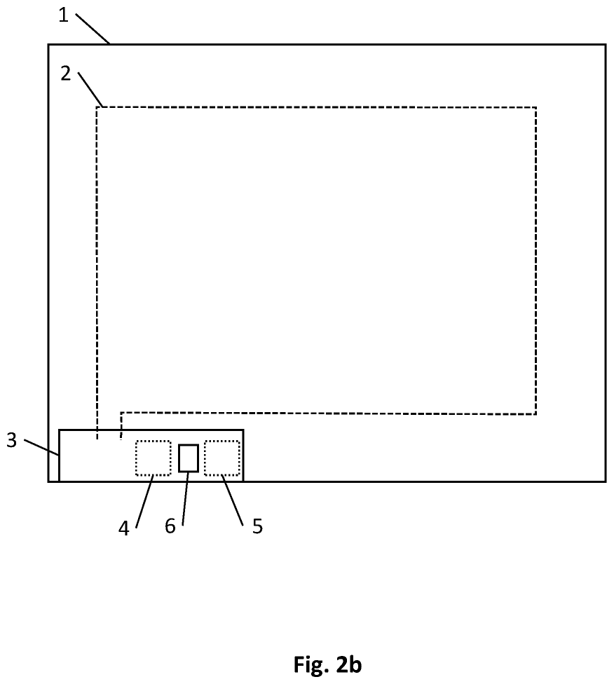

On this figure, a gap is shown between the two interlayers (12, 14). This gap is only present for showing purpose in order not to render the figure too complex. This gap is not actually present in the laminate. FIG. 2a also shows a heatable wired laminated glazing (1), but viewed from above. In this embodiment, the embedded conductive wires (2) form a snake pattern. As shown on FIG. 2b, in this embodiment, the embedded conductive wires (2) are shown as peripheral. Other pattern of conductive wires can be used. Depending on the width of the conductive wires as well as the optical sensor placed behind, the conductive wires can be placed out or in the field of view of the optical sensor.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1. A heated wired laminated glazing for a vehicle configured to be placed in front of an optical sensor, wherein the heated wired laminated glazing comprises:
a. an external glass sheet configured to face an outside of the vehicle, the external glass sheet having an external face and an internal face;
b. an internal glass sheet configured to face the optical sensor, the internal glass sheet having an external face and an internal face;
c. an interlayer configured to laminate the external glass sheet and the internal glass sheet together, the interlayer comprising embedded conductive wires;
d. a flat connector partially embedded between the interlayer and the external glass sheet or the internal glass sheet, the flat connector extending along the internal glass sheet and covering partially the external face of the internal glass sheet, the flat connector being connected to the embedded conductive wires, and the flat connector further comprising, on the part covering partially the external face of the internal glass sheet, a control circuit configured to control the embedded conductive wires;
wherein:
the flat connector further comprises, an active regulation system, on the part covering partially the external face of the internal glass sheet, configured to be connected to a battery of the vehicle;
the flat connector further comprises, on its part at least partially embedded between the interlayer and the external glass sheet or the internal glass sheet, at least one thermistor, on a part partially embedded between the interlayer and the external glass sheet or the internal glass sheet, and the at least one thermistor is connected to the control circuit through the flat connector.

2. The heated wired laminated glazing according to claim 1, wherein the heated wired laminated glazing comprises at least one additional interlayer laminated between the external glass sheet and the internal glass sheet.

3. The heated wired laminated glazing according to claim 2, wherein the flat connector is at least partially embedded between the interlayer and the at least one additional interlayer.

4. The heated wired laminated glazing according to claim 1, wherein the active regulation system is a DC/DC converter.

5. The heated wired laminated glazing according to claim 1, wherein the optical sensor is a lidar and the heated wired laminated glazing is transparent at an operating wavelength range of the lidar.

6. The heated wired laminated glazing according to claim 1, wherein the heated wired laminated glazing is a windshield, a rearlite or a sidelite.

7. The heated wired laminated glazing according to claim 1, wherein the heated wired laminated glazing is a cover of an optical sensor mounted on or inside the vehicle.

8. The heated wired laminated glazing according to claim 1, wherein the heated wired laminated glazing is a part of an exterior trim element of the vehicle.

9. The heated wired laminated glazing according to claim 1, further configured to be a windshield, a rearlite or a sidelite of the vehicle.

10. The heated wired laminated glazing according to claim 1, further configured to be a cover of an optical sensor mounted on or inside the vehicle.

11. The heated wired laminated glazing according to claim 1, further configured to be a part of an exterior trim element of the vehicle.
